(19) United States
(12) Patent Application Publication
(10) Pub. No.: US 2009/0140696 A1
(43) Pub. Date: Jun. 4, 2009

(54) Apparatus and method for correcting residual capacity measurement of battery pack

(76) Inventor: Tadashi Okuto, Longtan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/155,271

(22) Filed: Jun. 2, 2008

(30) Foreign Application Priority Data
Dec. 3, 2007 (TW) 96145956

(51) Int. Cl. H02J 7/00

(52) U.S. Cl. 320/134

(57) ABSTRACT

A device and method of calibrating a residual capacity measurement for a battery pack uses the charging and discharging mechanism to reset the capacity to zero every time when the battery pack is completely discharged, so as to precisely measure and display the real capacity. The device includes a battery pack and a battery protection unit electrically connected to the battery pack. The battery protection unit resets the minimal capacity when the battery pack is completely discharged. The device further includes a charging switch used to control the timing of the charging unit to charge the battery pack; a discharging switch used to control the timing of the discharging unit to discharge the battery pack; a microcontroller used to detect whether the device is connected to the charging unit and capacity messages are generated; and a discharging switch used to control the battery pack to be completely discharged.

### BACKGROUND OF THE INVENTION

1. Field of the Invention

The invention generally relates to a device and method of calibrating a residual capacity measurement for a battery pack, and more particularly to a device and method which uses the charging and discharging mechanism to obtain the accurate minimal capacity.

2. Description of the Related Art

Battery capacity is an important parameter for portable electronic products. The user usually knows the residual capacity from text displayed on a screen of the electronic products. The indicator for capacity of the electronic product detects the capacity via its internal circuit or an interface to acquire any information regarding to the residual capacity. The capacity information will be transmitted via data bus to a system and further processed by means of a power management mechanism of the system to generate the real-time capacity. For example, Windows®, Microsoft, issues a battery-low message when the residual capacity is 10% of full capacity, and further forces the system to enter to stand-by mode or even sleep mode when the residual capacity is 4% of full capacity.

However, the battery errors might existed between detected value and displayed value of the residual capacity, which is due to battery memory effect, or accumulated errors, after multiple times of charging/discharging cycles. If the errors occur, or no calibration is performed, the power management of the whole system will have serious problem. Failing to precisely detecting the low level of residual capacity will deteriorate the system, because the system fails to timely enter to the stand-by mode or sleep mode.

FIG. 1 is a graph of charging and discharging within ideal voltage. Ideally, the curves of charging and discharging are respectively in the range between the full charge voltage and end of discharge voltage. The battery can be fully charged or completely discharged.

In FIG. 2, during battery charging/discharging cycle, the memory effect, the accumulated errors and other factors lead to errors in detecting capacity, temperature correction or self-discharging correction. As shown by the solid line and the broken line, when the battery is continuously charged or discharged, the curves gradually deviates from the full charge voltage (100% capacity) and the end of discharge voltage (0% capacity). Therefore, the errors are accumulated, causing higher and higher errors in measuring capacity.

FIG. 3 shows the occurrence of those errors lead to failure of full charge or complete discharge, resulting in mismatch of the real capacity to the default capacity. Such mismatch will cause significant damage in the system due to incorrect judgment on the residual capacity for the electronic products.

FIG. 4 is a graph showing the system has wrong judgment on residual capacity in the art. As shown, the default full charge voltage is 100% capacity, while the end of discharge voltage is 0% capacity. In the case that the battery has been charged and discharged for multiple times, and the battery with the capacity of point a is going to be charged again, the battery will wrongly take the capacity of that point as the minimal capacity. If the minimal capacity is incorrectly set, then the service life of the battery will be reduced, and even deteriorate the system.

For example, the operation system of Windows® will issues battery-low message when the residual capacity is 10%, (point b), and a battery-dead message when the residual capacity is 4% (point c). At this moment, the system should enter to the stand-by mode in order to protect the data temporarily stored in the system. If the capacity is determined wrongly, the system might be damaged before enter to the stand-by mode, or has other problems due to misjudgment of residual capacity.

### SUMMARY OF THE INVENTION

A conventional capacity indicator in a portable device does not take the battery residual effect into consideration, and drives the battery to normal mode or stand-by mode according to the result of judging whether the battery is full, low or exhausted after compared to the defaults in the portable products or the operation system. However, the incorrect result of capacity judgment will lead the portable products or the operational system to erotic operation. The method and device of calibrating the residual capacity measurement for battery pack has solved the prior problems by charging and discharging mechanism which allows the battery pack to continue discharging until being completely exhausted while the portable device or the operational system is in stand-by mode, and then reset the minimal capacity to zero as a standard for accurately measuring the capacity.

The device of calibrating the residual capacity measurement for battery pack includes a battery pack electrically connected to a battery protection unit which resets the minimal capacity for the battery pack as a standard for accurately measuring the capacity.

A device of calibrating a residual capacity measurement for a battery pack according to the invention includes a battery pack and a battery protection unit electrically connected to the battery pack. The battery protection unit resets the minimal capacity when the battery pack is completely discharged. The device further includes a charging switch used to control the timing of the charging unit to charge the battery pack; a discharging switch used to control the timing of the discharging unit to discharge the battery pack; a microcontroller used to detect whether the device is connected to the charging unit and capacity messages are generated; and a discharging switch used to control the battery pack to be completely discharged.

A method of calibrating a residual capacity measurement for a battery pack measures the initial capacity. When a system enters to the stand-by mode due to low power, it will detect whether the system is connected to the charging unit. If the system is not connected to the charging unit, then stop discharging until the system is connected to the charging unit. When the system is connected to the charging unit, then the discharging process is triggered until the battery pack is completely discharged. At this moment, a minimal capacity is reset to zero as a standard for accurately measuring the capacity of the battery pack.

When the capacity of the battery pack is low, the microcontroller transmits alarming messages to the system. When the battery pack is exhausted, the microcontroller transmits anther alarming messages, indicating the system enters to the stand-by mode. Similarly, if the system is not connected to the charging unit, no discharging process is performed. If the system is connected to the charging unit, then the discharging process is performed. When the battery pack is completely discharged, the battery protection unit resets a minimal capacity to zero as a standard of accurately measuring the capacity. At this moment, it starts to charge the battery pack.

To provide a further understanding of the invention, the following detailed description illustrates embodiments and examples of the invention, this detailed description being provided only for illustration of the invention.

### BRIEF DESCRIPTION OF THE DRAWINGS

FIG. 1 is a graph of charging and discharging with theoretical capacity in the art;

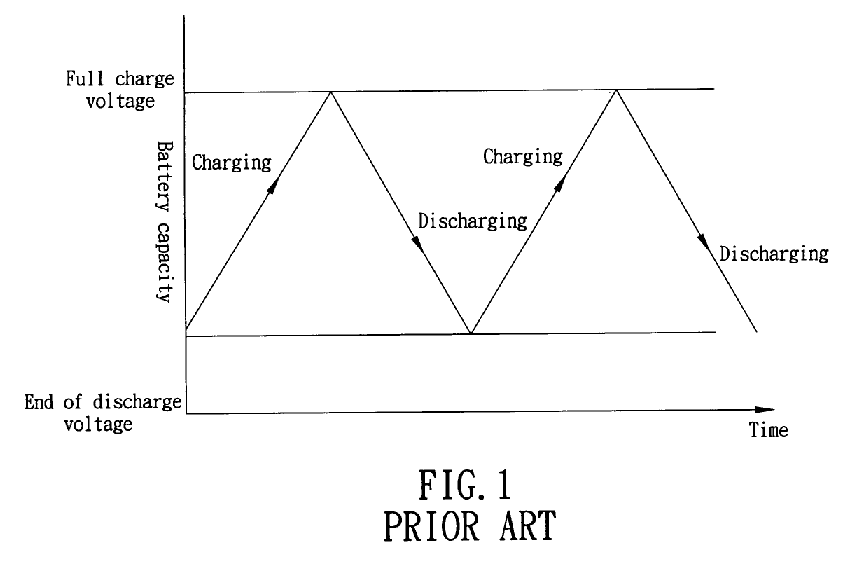

FIG. 2 is a graph of errors generated due to charging and discharging in the art;

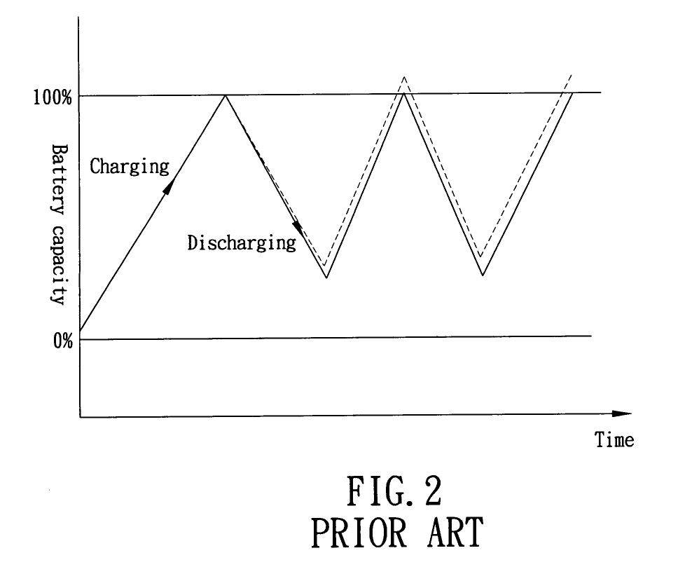

FIG. 3 is a graph of errors generated due to charging and discharging in the art;

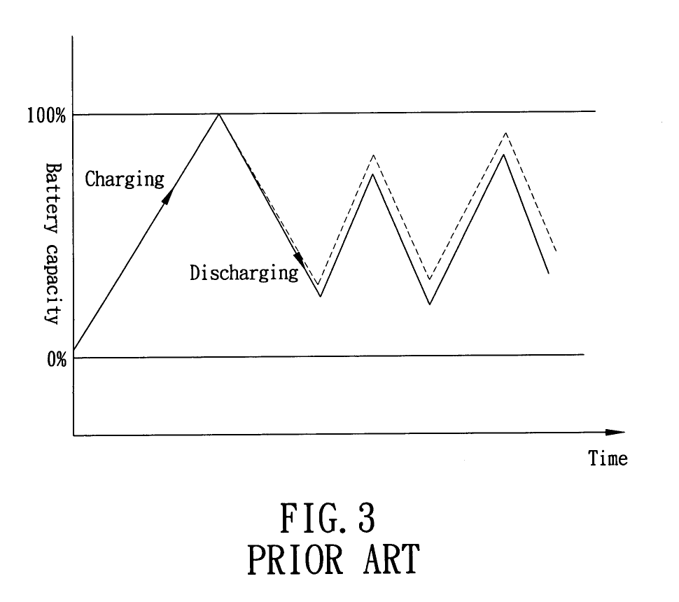

FIG. 4 is a graph showing a power management system makes mistakes due to errors generated by charging and discharging in the art;

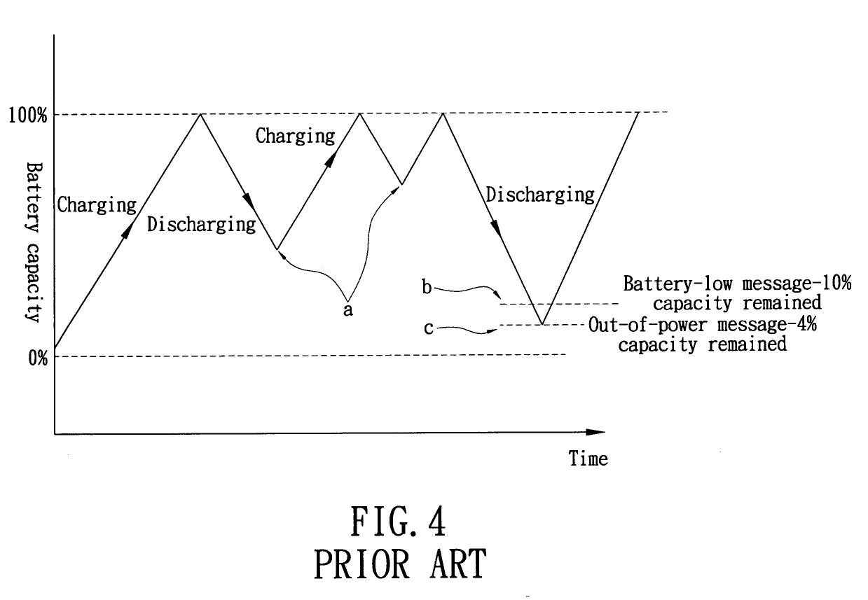

FIG. 5 is a graph of charging and discharging according to one embodiment of the invention;

FIG. 6 is a schematic view of a device of calibrating residual capacity measurement for a battery pack according to one embodiment of the invention;

FIG. 7 is a flow chart of a method of calibrating residual capacity measurement according to one embodiment of the invention;

FIG. 8 is a flow chart of a method of calibrating residual capacity measurement according to one embodiment of the invention.

### DETAILED DESCRIPTION OF THE EMBODIMENTS

Wherever possible in the following description, like reference numerals will refer to like elements and parts unless otherwise illustrated.

Here below, the term “system” is referred to as a portable device such as laptop, personal computer, personal digital assistant, and portable communication device including the inside operation system.

Power supply is important to those it is applied, especially to a portable device such as laptop, personal computer, personal digital assistant, and portable communication device. The user relies on the residual power indicator on the operation system of the portable device to acknowledge the available operation time. However, the residual power indicator is designed without taking the battery residual effect into account. Instead, the residual power indicator uses the default battery capacity to determine whether the capacity is full, low or exhausted, and drives the power supply to normal mode or stand-by mode. If the determined residual capacity is not equal to the actual residual capacity, the residual power indicator will make incorrect indication for the user.

A calibrating device for residual capacity of battery pack according to the invention and the method of calibrating the residual capacity of battery pack according to the invention utilize different scheme to discharge continuously until completely consume even when the portable device enters stand-by mode. Furthermore, a minimal capacity is reset to zero as a calculation base for the residual capacity power indicator so as determine more precisely in the coming charging circle.

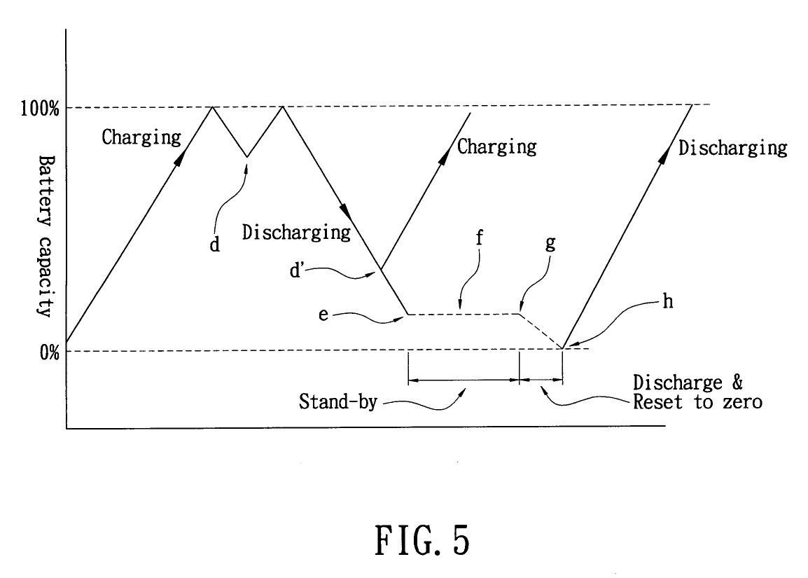

FIG. 5 is a graph of charging and discharging in calibrating the residual capacity of battery pack according to one embodiment of the invention. The vertical axis represents the capacity of the battery pack, wherein 100% indicates the battery pack are fully charged, and 0% indicates the battery pack are completely discharged. The horizontal axis represents time. The graph in FIG. 5 shows the residual capacity of battery pack at every time point.

Battery pack capacity at point d and point d′ are charging curves when the battery pack has undead capacities. The invention charges battery pack when the battery pack doesn't reach low capacity and connect to an external power supplier. The capacity curve goes upward after the point d and point d′.

Point e indicates the battery pack capacity is close to exhaust, and it will inform users of relevant warning contents in any form of sounds or pictures generated by the portable device or its operation system. Soon after this moment, the portable device is going to turn to stand-by mode or sleep mode.

Point f indicates the status when the battery pack is in stand-by mode (or non-shown power management systems) and it doesn't connect to the charging unit. For example, the battery pack have consumed their capacities already while the laptop which needs an external power adapter for an external power supply fails to connect to the external power supply. The portable device can be kept at stand-by mode with a small capacity with the time period at point f, they are not charged or discharged.

Point g indicates the portable device is connected to a charging unit. The portable device is discharging between the point g and the point h until reach the End of Discharge Capacity at the point h. The portable device will reset the minimum capacity of the battery pack as 0% so as to eliminate the residual power error generated due to repeatedly charging or the power measurement error due to battery memory effect. The portable device can precisely measure the remaining capacity of the battery pack using the reset minimal capacity as standard to indicate an accurate residual capacity onto a remaining capacity display system. Thereafter, the charging unit performs the charging process, as shown the increasing capacity curve after the point h.

The invitation provides a charging and discharging mechanism for battery pack to reach fully discharged voltage. Therefore, it can fully utilize battery power, also measure and display accurate remaining capacity.

The invention provides a device of calibrating the residual capacity of battery pack, and further a method of calibrating the residual capacity of battery pack, especially measuring the lowest capacity by using charging and discharging mechanism.

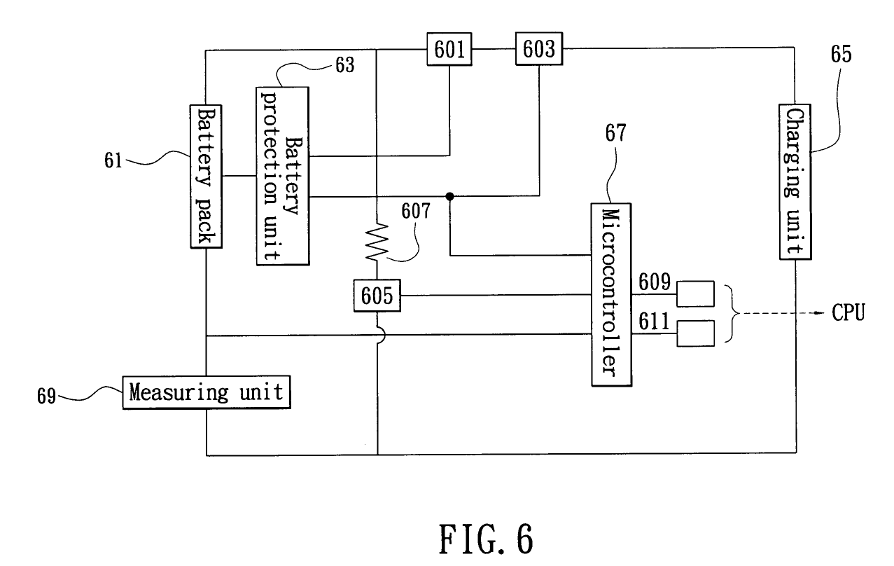

FIG. 6 is a device of calibrating the measurement of the residual capacity of battery pack by using charging and discharging mechanism according to one embodiment of the invention. This embodiment can be applied to the power management system of portable device such as laptop, personal computer, and portable communication devices.

As shown, a battery pack 61 includes one or multiple cells, especially for lithium battery pack. The battery pack 61 has a battery protection unit 63 to protect the pack 61 from being over charged, over discharged or generating over current. When the battery pack 61 is over charged, the battery protection unit 63 switches off a charging switch 603 to stop charging. When the battery pack 61 is over discharged or experiencing current surges, the battery protection unit 63 switches off a discharging switch 601 to stop discharging. When the battery pack is discharged completely, the battery protection unit 63 is used to reset the minimal capacity for the battery pack 61.

The battery pack 61 is further electrically connected to the charging unit 65. The portable device is further connected to an external power supply via the charging unit. However, it is not always connect the charging unit 65 to the power management system. A charging circuit of the charging unit 65 used to charge the battery pack 61 is controlled by a charging switch 603 electrically connected to the battery protection unit 63, the charging unit 65 and the battery pack 61. When the battery pack 61 needs to be charged, the battery protection unit 63 switches on the charging switch 603 to allow the current to run through the battery pack 61.

A discharging switch 601 electrically connected to the battery protection unit 63, the charging unit 65 and the battery pack 61 is used to control a discharging circuit of the battery pack 61. When the battery pack 61 needs to be discharged or provide power to system load, the battery protection unit 63 switches on the discharge switch 601 to discharge the battery pack 61.

The power management system further includes a microcontroller 67, which is electrically connected to a battery protection unit 63. The charging switch 603 is controlled by the microcontroller 67. When the power management system enters stand-by mode and is connected to the charging unit 65, the microcontroller 67 switches off the charging switch 603 to stop the charging unit 65 from charging the battery pack 61. The battery pack 61 will not be charged until the battery pack is completely exhausted. The main purpose is using signal to control charging mechanism. Depending on different status of the system, it will generate signal to stop or start charging.

The microcontroller 67 is used to detect if the charging unit 65 is connected, and generates one or more capacity messages obtained by a measuring unit 69. The capacity messages include residual capacity displayed on the display system, alarming messages when the capacity is low, the alarming messages when the capacity reaches the exhausted levels. The microcontroller 67 transmits the capacity messages to a central processor unit (CPU) of the portable device via terminals 609 and 611.

In one embodiment, the microcontroller 67 is informed by the measuring unit 69 of the capacity of the battery pack 61 which is obtained from the voltage drop or the volume of current inside the battery pack 61. The microcontroller 67 is further connected to an internal discharging switch 605 which is connected to a resistor 607 and across two electrodes of the battery pack 61. The microcontroller 67 forces the battery pack 61 to complete discharge when the battery pack 61 is nearly exhausted and connected to the charging unit 65. It is noted that the resistance of the resistor 607 will affect the discharging rate.

The microcontroller 67 aims at controlling the charging and discharging timings to measure the capacity of the battery pack 61 with higher accuracy.

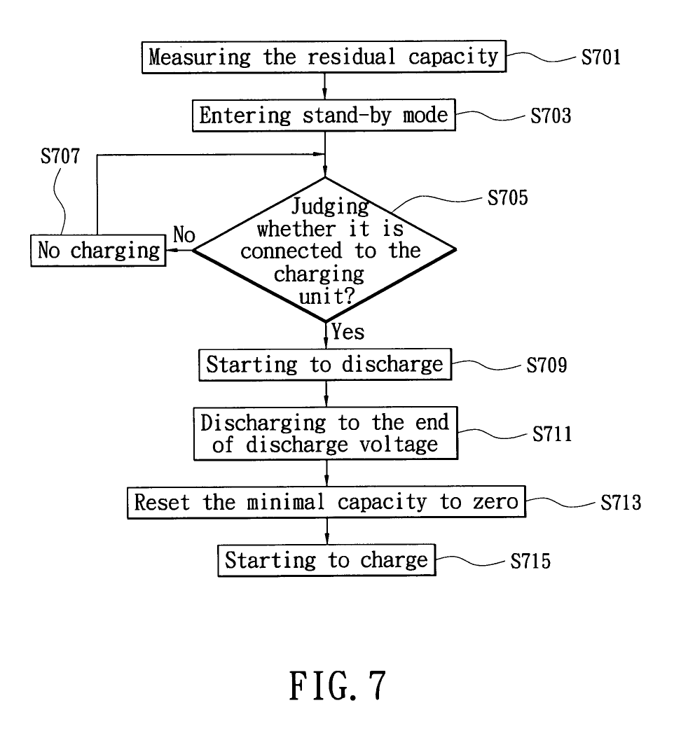

FIG. 7 is a flow chart of a method of calibrating the residual capacity measurement on the battery pack according to one embodiment of the invention. Step S701 represents the measuring unit continuously measures the capacity of the battery pack and the microcontroller acknowledges the measured capacity from time to time and accordingly controls the charging and discharging.

When the portable device enters to the stand-by mode, it means the power of the battery pack has consumed already (Step S703). At this moment, the portable device stops discharge, and the battery protection unit switches off the discharging switch. Meanwhile the microcontroller detects whether the charging unit is connected (Step S705). If the charging unit is not connected, then the charging switch is switched off to maintain the battery pack at stand-by mode.

Step S709 represents if the microcontroller detects that the charging unit has been connected to the portable device, then the discharging switch is switched on to start the discharging process via such as resistors. The discharging rate (not long time to reach complete discharge) and variation in temperature within the portable device (high discharge rate will contribute to duly high temperature) are needed to take into consideration to obtain a proper resistance value. Then, discharge will continue until the power has exhausted, i.e., 0% of capacity (Step S711).

The minimal capacity is reset to 0 (Step S713), and then starts to charging (Step S715). Furthermore, when the battery pack is fully charged, the capacity is set to 100% as another standard for calculating the residual capacity.

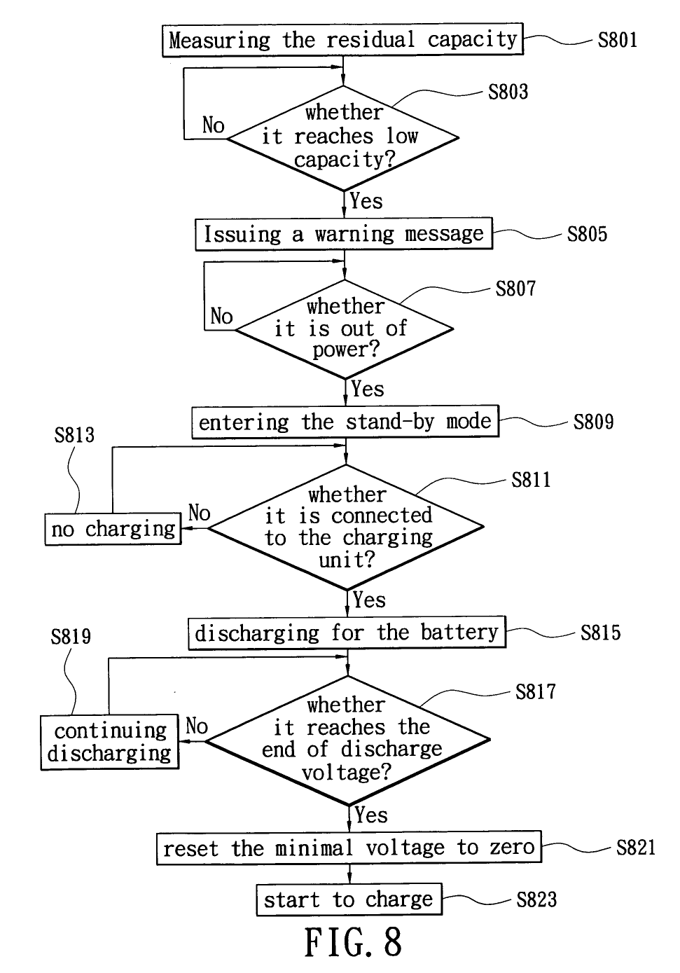

FIG. 8 is a flow chart of a method of calibrating capacity measurement according to one embodiment of the invention. A power management module continuously measures the capacity of the battery pack (Step S801). The microcontroller judges if the capacity is low via the measuring unit. (Step S803). If yes, then a low capacity alarming message is transmitted to the management system (Step S805). After the low-capacity alarm, the management system keeps operating while the microcontroller keeps an eye on whether the power of the battery pack has been exhausted. (Step S807). When the power is running out, the microcontroller will warn in various ways to inform the management system to be stand-by mode (Step S809) or other similar modes.

At Step S811, the microcontroller stays in operation with small power to detect whether the portable device is connected. If NO, then stop the charging process and keep the portable device at stand-by mode (Step S813). However, if the portable device is connected to the charging unit, then the microcontroller switches on the discharging switch to perform the discharging process (Step S815). Then, judge whether the battery is completely discharged. (Step S817).

The discharging rate will be determined by the system, depending on the system temperature and capacity level. If the capacity level is not completely discharged, even though the charging unit is connected, the microcontroller still does not proceed charging. Instead, the charging switch is switched off and the battery pack is continuously discharged (Step S819) until completely exhausted. The capacity is reset to 0%, the minimal value (Step S821) to eliminate any errors generated by various battery effects. Start to charge the battery pack (Step S823). When the battery pack is full of power, then the capacity is reset to 100%, the maximal value, for accurately measuring the residual capacity.

Therefore, the device and method of the invention achieves the calibration of the residual capacity measurement for a battery pack by utilizing charging and discharging mechanism. Even though the battery pack is nearly exhausted and connected to the external power supply, it is still discharging until completely exhausted and then resets that consumed capacity as minimum value so as to increase the accuracy of residual power measurement.

It should be apparent to those skills in the art of the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A method of calibrating a residual capacity measurement for a battery pack, comprising:
measuring the capacity of a battery pack;
a system entering a stand-by mode when power is exhausted;
detecting whether the system is connected to a charging unit;
stopping discharging if the system is not connected to the charging unit;
discharging if the system is connected to the charging unit; and
when the battery pack is completely discharged, then reset the minimal capacity to zero as a standard for accurately measuring the capacity of the battery pack.

2. The method of claim 1, wherein the system is a portable device.

3. The method of claim 1, wherein the system enters to stand-by mode and the battery protection unit switches off a discharging switch.

4. The method of claim 1, wherein if the system is not connected to the charging unit, then switch off a discharging switch to stop discharging and switch off a charging switch.

5. The method of claim 1, wherein if the system is connected to the charging unit, then switch on a discharging switch to perform the discharging process.

6. The method of claim 1, wherein when the system enters to the stand-by mode and is connected to the charging unit, then a microcontroller switches off a charging switch so that the charging unit cannot perform the charging process on the battery pack.

7. The method of claim 1, wherein when the battery pack is completely exhausted, then start charging the battery pack.

8. The method of claim 7, wherein when the battery pack is full of power, a maximal capacity is reset to 100% as another standard for accurately measuring the capacity of the battery pack.

9. A method of calibrating a residual capacity measurement for a battery pack, comprising:
measuring a capacity of the battery pack;
transmitting a first alarming message to a system via a microcontroller when the capacity of the battery pack reaches a low capacity value;
transmitting a second alarming message to the system via a microcontroller when the battery pack is exhausted and enters to a stand-by mode;
the microcontroller detecting whether the system is connected to a charging unit;
if the system is not connected to the charging unit, then stop discharging and switch off a charging switch;
if the system is connected to the charging unit, then perform discharging;
when the battery pack is completely discharged, then a battery protection unit resets the minimal capacity to zero as another standard for accurately
measuring the capacity of the battery pack; and
the charging unit perform the charging process.

10. The method of claim 9, wherein the system wherein the system is a portable device.

11. The method of claim 9, wherein the system enters to stand-by mode and the battery protection unit switches off a discharging switch.

12. The method of claim 9, wherein the battery protection unit switches on the charging switch to perform the charging process.

13. The method of claim 9, wherein if the system is not connected to the charging unit, then the microcontroller switches off a discharging switch to stop the discharging process and switches off the charging switch.

14. The method of claim 9, wherein if the system is connected to the charging unit, then the microcontroller switches on a discharging switch to perform the discharging process.

15. The method of claim 9, wherein when the battery pack is completely charged, then a maximal capacity is reset to 100% as another standard for accurately measuring the capacity of the battery pack.

16. A device for calibrating a residual capacity measurement for a battery pack, comprising:
a battery pack;
a battery protection unit, electrically connected to the battery pack to prevent the battery pack from being damaged due to over charged, over discharged or duly high current, wherein a minimal capacity is reset;
a charging switch, electrically connected to the battery protection unit to control a circuit of a charging unit used to charge the battery pack;
a discharging switch, electrically connected to the battery protection unit to control circuit used to discharge the battery pack;
a microcontroller, electrically connected to the battery protection unit to detect whether the device is connected to the charging unit and generate one or more capacity messages; and
a discharging switch, electrically connected to the battery pack and the microcontroller to discharge the battery pack up to completely discharged level.

17. The device of claim 16, further comprising a capacity measuring unit electrically connected to the battery pack and the microcontroller to measure the capacity of the battery pack.

18. The device of claim 16, further comprising a resistor electrically connected battery pack to control the discharge rate of the battery pack.

19. The device of claim 16, wherein the microcontroller has one or more communication ports which are connected to a computer system.

20. The device of claim 19, wherein the microcontroller transmits capacity messages via the communication ports, the messages including alarming messages when the capacity is low or the capacity reaches the exhausted level.

21. The device of claim 16, wherein the charging switch is controlled by the microcontroller, and when the system has not entered to stand-by mode yet, and has been connected to the charging unit, the microcontroller switches off the charging switches to stop the charging unit from charging the battery pack.
